(19) United States
(12) Patent Application Publication
(10) Pub. No.: US 2006/0046954 A1
(43) Pub. Date: Mar. 2, 2006

(54) Rinse aid compositions and methods

(76) Inventors: Kim R. Smith, Woodbury, MN (US); Keith E. Olson, Apple Valley, MN (US)

Correspondence Address: ECOLAB INC., MAIL STOP ESC-F7, 655 LONE OAK DRIVE, EAGAN, MN, 55121, US

(21) Appl. No.: 10/931,465

(22) Filed: Sep. 1, 2004

(51) Int. Cl. C11D 3/37

(52) U.S. Cl. 510/514

(57) ABSTRACT

Rinse aid compositions and methods for using and methods for making the compositions for warewashing processes. In one aspect, the rinse aid composition includes ingredients listed on the FDA GRAS (“generally recognized as safe”) list, including 21 C.F.R. 172 and/or 21 C.F.R. 178; preferably, all the ingredients are listed on the GRAS list. The rinse aid composition includes at least two ethylene oxide-propylene oxide (EO/PO) copolymers, with at least one of those EO/PO copolymers being PO-terminated. The rinse aid composition can include two PO-terminated EO/PO copolymers.

### FIELD

The invention relates to warewashing processes and chemicals used in washing cookware, dishware and flatware. More particularly, the invention relates to rinse aids that can be added to promote a sheeting action during warewashing processes. Such rinse aids promote effective sheeting to result in cookware, dishware and flatware with minimal water-spotting, and are low foaming and non-toxic.

### BACKGROUND

Rinse aids are used in automatic dishwashers to help minimize water spotting on tableware, glassware and cookware (in combination, referred to as “ware”) during the rinsing and drying steps. Rinse aids function by reducing the contact angle of the water on the ware surface, permitting water to sheet off the surface rather than being retains as water droplets. Water droplets, as they dry, cause water spots.

Commercial rinse aids typically contain one or more sheeting agents as well as a hydrotrope, defoamer and humectant. Examples of known sheeting agents include ethylene oxide-propylene oxide copolymers (EO/POs) such as PLURONIC® and PLURONIC® R products from BASF, anionic hydrotropes such as sodium xylene sulfonate, and humectants such as glycerin and propylene glycol. Hydrotropes are typically low molecular weight, high foaming anionic surfactants such as sodium xylene sulfonate, potassium xylene sulfonate, and sodium cumene sulfonate. Hydrotropes, particularly anionic hydrotropes cause foaming; thus, a defoamer is usually added to the rinse aid.

Due to their point of use in the final rinse, rinse aids remain on the clean tableware, glassware and cookware, which has led the FDA to consider rinse aids as a food additive.

Therefore, it would be advantageous to have a rinse aid having all ingredients considered safe as an indirect or direct food additive. The FDA provides a GRAS (“generally recognized as safe”) list for food additives. The GRAS indirect food additives are defined by 21 C.F.R. 178, 181, and 186 and direct food additives by 21 C.F.R. 172 and 582. It would be desired to be able to provide a rinse aid that consists solely of active ingredients from the GRAS list and that functions adequately by providing suitable sheeting and non-spotting action without the need for a defoamer.

Attempts have been made to produce such rinse aids. U.S. Pat. No. 5,589,099 to Baum provides a food grade rinse aid composed of an EO/PO copolymer having a high cloud point, a food additive defoamer composition, and a water soluble diluent composition.

However, additional compositions that are food safe, and which have all GRAS ingredients, are desired.

### SUMMARY OF THE DISCLOSURE

The present invention relates to rinse aid compositions and methods for using and methods for making the compositions for warewashing processes.

In one aspect, the rinse aid composition includes ingredients listed on the GRAS (“generally recognized as safe”) list, which includes 21 C.F.R. 172, 21 C.F.R. 178, 21 C.F.R. 181, 21 C.F.R. 186, and 21 C.F.R. 582. With the exception of water, all of the ingredients are listed on the GRAS list.

In another aspect, the rinse aid composition comprises at least two EO/PO copolymers, at least one of them being PO-terminated, such that composition itself is stable and its dilution phase separates during use. The composition has a cloud point of no greater than 120° F. when the composition has solids of about 1 wt-% or less, and the composition has a cloud point of about 130° F. or greater when the composition has solids of 10 wt-%. In yet another aspect, the composition has a cloud point of no greater than about 110° F. when the composition has an EO/PO concentration of 1 wt-%, and the composition has a cloud point of about 140° F. or greater when the composition has solids concentration of 10 wt-%. This combination of cloud points give a stable rinse aid composition under storage conditions, but where its diluted product phase separates under use conditions, thus being self-defoaming without the need for any defoamer.

As stated above, the rinse aid composition includes at least two ethylene oxide-propylene oxide (EO/PO) copolymers, with at least one of those EO/PO copolymers being PO-terminated. These copolymers are present in an amount to provide effective water sheeting when about 2 mL of rinse aid composition is added to a dishwasher. Typically, 1-100 wt-% of the rinse aid composition is EO/PO copolymer.

The rinse aid composition does not include a hydrotrope, such as an anionic hydrotrope. Not to be limited by theory, the rinse aid composition is believed to form a microemulsion of the EO/PO copolymers in water to provide product stability, eliminating the need for a hydrotrope. This elimination of hydrotropes from the rinse aid reduces the foam generated and hence the need for a defoamer agent.

The composition may be a liquid product, a gel, or a solid product. A solid product may be produced using urea or PEG as a solidification agent in a variety of processes known to the art.

Additional details regarding the rinse aid composition and methods are provided below.

### DETAILED DESCRIPTION OF THE INVENTION

The present invention is directed to a rinse aid composition and use of that composition for tableware, glassware, silverware, serving utensils, and other various items and surfaces (i.e., “ware”).

Throughout this description, the described composition is generally a “concentrate”. By use of the term “concentrate”, what is intended is a solution or mixture of ingredients present at a level stronger than needed to obtain sufficient surface modification according to the method of the invention. The rinse aid concentrate is the form that the rinse aid is provided, for example, to the dishwasher. The rinse aid concentrate, if present as a liquid product, has a solids level of about 1-50 wt-%; if present as a solid product, the concentrate typically has a solids level of about 80-100 wt-%. During a rinse cycle of a dishwasher, the composition concentrate is diluted with water to form a “use composition”. The use composition has a solids level of no greater than about 1 wt-%, typically no greater than about 0.1 wt-%. Typically during use, the solids are present at a level of less than about 0.05 wt-%.

As used herein, “weight percent”, “wt-%”, “percent by weight”, “% by weight”, and variations thereof refer to the concentration of a substance as the weight of that substance divided by the total weight of the composition and multiplied by 100. It is understood that, as used here, “percent”, “%”, and the like are intended to be synonymous with “weight percent”, “wt-%”, etc.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The Rinse Aid Composition

The rinse aid composition of the present invention is composed of ingredients that qualify as being food-additive safe. That is, the ingredients are listed on the FDA's GRAS (“generally recognized as safe”) list for direct and indirect food additives. The GRAS indirect food additives, for adjuvants, production aids and sanitizers, are defined by 21 C.F.R. 178, 21 C.F.R. 181, and 21 C.F.R. 186 and direct food additives are defined by 21 C.F.R. 172 and 21 C.F.R. 582. Preferably each of the ingredients in the rinse aid composition are listed on the GRAS list of 21 C.F.R. 178, and even more preferably, on the list of 21 C.F.R. 172.

Further, the rinse aid composition, in its concentrate form, has a cloud point of about 130° F. or higher, and, in its use form, a cloud point of less than or about 120° F. Additionally, the rinse aid composition in a concentrate form with about 10 wt-% solids has a cloud point of about 130° F. or higher, and in its use dilution having less than or about 1 wt-% solids has a cloud point of about 120° F. or lower. The 10 wt-% or greater solids concentration is indicative of a typical rinse aid composition concentrate, prior to being used in a washing process. It is desired that the rinse aid composition does not precipitate or otherwise phase separate prior to use, for example, while sitting on a warehouse shelf or in a kitchen. The temperature to which the 10 wt-% solids concentration is exposed generally does not rise over 130° F. Thus, a product with a cloud point of about 130° F. or higher will not phase separate at typical storage temperatures. The 1 wt-% or less solids concentration is indicative of a typically rinse aid composition, in use during a rinsing process. It is desirable that the use solution rinse aid composition does phase separate during use. The temperature to which the 1 wt-% concentration is exposed is usually at least 120° F., often higher. Thus, a product with a cloud point of about 120° F. or lower will phase separate at typical washing and rinsing temperatures, which are greater than 120° F. This separation during use defoams the use solution, thus avoiding the need for a defoamer.

Although defoaming of rinse aid use solutions through phase separation is known in the art, it is unexpected that a composition would be able to have the combination of a stable concentrate, with a cloud point above 130° F., and a defoaming unstable use solution, with a cloud point below 120° F., without the use of a high foaming anionic hydrotrope or defoamer. The literature on cloud points of nonionic surfactant reports the opposite type behavior in which a concentrate when diluted with water will exhibit an increase in cloud point. The key to this unexpected behavior is the presence of a mixture of at least two EO/PO copolymers, with at least one of those copolymers being PO-terminated.

In its most basic aspect, the present rinse aid composition includes a mixture of at least two EO/PO copolymers, with at least one of those copolymers being PO-terminated. Preferably, at least two of the EO/PO copolymers present are PO-terminated. Most preferably, all of the EO/PO copolymers present in the composition are PO-terminated. EO/PO copolymers are found on the GRAS list, under section 21 C.F.R. 172.808 as “copolymer condensates of ethylene oxide and propylene oxide”.

Although the term “mixture” is used to refer to the combination of the EO/PO copolymers, the combination may be present as a solution, a microemulsion, liquid crystal, or any other combination which is non-phase separating in the concentrate composition. Applicants are not intending to be bound by any theory or definition regarding the various forms of mixtures.

EO/PO Sheeting Agents

EO/PO copolymers are copolymer condensates of ethylene oxide and propylene oxide and fall within the broad class of nonionic surfactants. The EO/PO copolymers reduce the contact angle of water on the surface being rinsed, thus providing sheeting action for the rinse aid composition. A variety of nonionic surfactants, or mixtures of nonionic surfactants, can be employed, however, at least two EO-PO copolymers are present, with at least one of the copolymers being PO-terminated.

Nonionic surfactants, including EO/PO copolymers, can be described in terms of their cloud point, which is directly dependent on solubility. The cloud point is the temperature at which a dilute solution of the material clouds. This clouding is due to the phase separation of the mixture. It is well established that cloud points increase as the concentration of nonionic surfactant in a mixture decreases, and decrease as nonionic surfactant concentration increases. See for example, Surface Active Ethylene Oxide Adducts by N. Schönfeldt (1969). On page 145 et seq. of this text, cloud points are discussed. Page 146 provides Table 35A, which provides specific examples of cloud points as related to concentration. See also for example, Nonionic Surfactants by Martin Schick (1967), pages 571-582.

At temperatures below the mixture's cloud point, the mixture is stable, and there is no phase separation. At temperatures above the desired cloud points, the mixture phase separates or clouds. Upon phase separation, the mixture defoams. Thus, when the mixture is present at a temperature above its cloud point, the mixture inherently defoams, thus not needing a defoamer additive.

It is well accepted in the chemical arts that a mixture of two nonionic surfactants, each having its cloud point at a specified concentration, would result in a mixture having a cloud point that is the arithmetic average of the individual cloud points, by volume. For example a 2:1 mixture of nonionic surfactants A:B will have a cloud point that is ⅔*cloud point of A+⅓*cloud point of B. See for example, a surfactant brochure from Shell Chemical Company for NEODOL® EO/PO copolymers, the brochure being titled “A Complete Line for Textile Applications”. Table E, on page 5 of the brochure, lists the cloud point of Neodol N25-7 as 47.0° C.; the cloud point of Neodol N25-9 as 74.0° C.; and the cloud point of a 50/50 mixture of N25-7 and N25-9 as 60.5° C., which is the arithmetic average of the cloud points. See also, Nonionic Surfactants, pages 588-589, which discuss similar properties for mixtures of nonionic surfactants. In this invention, however, Applicants determined that when using EO/PO copolymers, which are nonionic surfactants, with at least one of the copolymers being PO-terminated, this arithmetic mean does not apply.

Applicants found that when a mixture of EO/PO copolymers, when two PO-terminated polymers were used, the resulting cloud point of the mixture was not the theoretically expected cloud point. See Example 1, below, which provides a listing of expected cloud points and experimentally tested cloud points for two EO/PO PO-terminated copolymers and an aliphatic, alcohol ethoxylate. Applicants believe that this same phenomenon applies if one copolymer is PO-termination and another is EO-terminated.

Additionally, Applicants found that a mixture of EO/PO copolymers, having two PO-terminated polymers, does not follow the convention of having a higher cloud point at lower concentration and a lower cloud point at higher concentration. Rather, Applicants found that the cloud point of mixtures of PO-terminated EO/PO copolymers decreases as the concentration decreases and increases as the concentration increases. See Example 1.

The EO/PO copolymers used in the rinse aid composition of the present invention are selected so that, when combined, the cloud point of the mixed copolymers decreases with decreasing concentration and increases with increasing concentration. When at a concentration of 10 wt-% EO/PO copolymers, the cloud point of the composition is at least about 130° F., and when at a concentration of about 1 wt-%, the cloud point is no more than about 120° F. In an alternate preferred composition, the EO/PO copolymers used in the rinse aid composition of the present invention are selected so that, when combined, the cloud point of the mixed copolymers, when at a concentration of 10 wt-% EO/PO copolymers, is at least 140° F., and when at a concentration of 1 wt-% or less, the cloud point is no more than 110° F.

As stated above, a 10 wt-% concentration is indicative of a rinse aid composition prior to being used; for example, when the composition is being stored. At this stage, it is desired that the rinse aid composition does not cloud or otherwise phase separate. The temperature to which the 10 wt-% concentration is exposed generally does not rise over 130° F. Thus, a product with a cloud point of about 130° F. or higher will not cloud at typical storage temperatures. The 1 wt-% or less concentration is indicative of a typical rinse aid composition during use. At this stage, it is acceptable, and often desired, that the rinse aid composition does cloud or phase separate during use. Phase separation results in in situ defoaming. The temperature to which the 1 wt-% concentration is exposed is usually at least 120° F., often higher. Thus, a product with a cloud point of about 120° F. or lower will cloud at typical washing and rinsing temperatures, which are greater than 120° F.

As stated above, the present rinse aid composition includes a mixture of at least two EO/PO copolymers, with at least one of those copolymers being PO-terminated. The EO/PO copolymers reduce the contact angle of the water on the surface being rinsed and provide sheeting action. The EO/PO copolymers, at least one being PO-terminated, provide a composition sufficiently stable such that no emulsifying agent, such as a hydrotrope, is needed in the rinse aid composition.

Examples of suitable, commercially available PO terminated EO/PO copolymers include some available from BASF under the tradenames PLURONIC® R and TETRONIC® R and from Huntsman Chemical under the tradename SURFONIC®. Two particular examples of PO-terminated EO/PO copolymers are “Pluronic 25R8” (available from BASF), “Surfonic LDO-97” (available from Huntsman Chemical). Other PO-terminated copolymers are also suitable for use in the rinse aid composition.

The copolymers are present in the composition in an amount to provide effective water sheeting when 2 ml of rinse aid is added to a standard, residential dishwasher.

Usually, liquid rinse aid composition concentrates according to the present invention contain no more than about 50 wt-% EO/PO copolymer and typically no more than about 20 wt-%. One embodiment includes about 1-20 wt-% copolymer. One particular embodiment includes about 10 wt-% copolymer; a second particular embodiment includes about 5 wt-% copolymer. A solid rinse aid composition concentrate may have up to 100 wt-% EO/PO copolymer.

The rinse aid composition may include another nonionic surfactant other than the EO/PO copolymers to provide additional sheeting action and other desirable properties. A variety of nonionic surfactants, or mixtures of nonionic surfactants, can be employed. Useful nonionic surfactants are commercially available from a number of sources. Examples of suitable nonionic surfactants include alkyl-, aryl-, and aralkyl-, alkoxylates, alkylpolyglycosides and their derivatives, amines and their derivatives, and amides and their derivatives.

Additional useful nonionic surfactants include those having a polyalkylene oxide polymer as a portion of the surfactant molecule. Such nonionic surfactants include, for example, chlorine-, benzyl-, methyl-, ethyl-, propyl-, butyl- and other like alkyl-capped polyethylene and/or polypropylene glycol ethers of fatty alcohols; polyalkylene oxide free nonionics such as alkyl polyglycosides; sorbitan and sucrose esters and their ethoxylates; alkoxylated ethylene diamine; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and ethoxylated amines and ether amines and other like nonionic compounds. Silicone surfactants can also be used.

Additional suitable nonionic surfactants having a polyalkylene oxide polymer portion include nonionic surfactants of C6-C24 alcohol ethoxylates (preferably C6-C14 alcohol ethoxylates) having 1 to about 20 ethylene oxide groups (preferably about 9 to about 20 ethylene oxide groups); C6-C24 alkylphenol ethoxylates (preferably C8-C10 alkylphenol ethoxylates) having 1 to about 100 ethylene oxide groups (preferably about 12 to about 20 ethylene oxide groups); C6-C24 alkylpolyglycosides (preferably C6-C20 alkylpolyglycosides) having 1 to about 20 glycoside groups (preferably about 9 to about 20 glycoside groups); C6-C24 fatty acid ester ethoxylates, propoxylates or glycerides; and C4-C24 mono or dialkanolamides.

Usually, liquid rinse aid concentrate compositions according to the present invention will contain no more than about 20 wt-% nonionic surfactant (in addition to the EO/PO copolymers) and typically no more than about 10 wt-%.

Water

The rinse aid composition of the present invention preferably and typically includes water as the carrier for the composition. The water can be any type suitable for use in rinse aid compositions, such as tap water, softened water, unsoftened water, spring water, and deionized water. A preferred water for use in the composition and methods of using the composition is softened water, typically having a less than 20 grain hardness.

Usually, liquid rinse aid concentrate compositions according to the present invention will contain no more than about 98 wt-% water and typically no more than about 90 wt-%. Usually, liquid rinse aid composition concentrates will contain at least 50 wt-% water, typically at least 80 wt-%. One embodiment includes about 50-98 wt-% water, and preferably about 70-90 wt-%. One particular embodiment includes about 90 wt-% water; a second particular embodiment includes about 80 wt-% water. In use, these rinse aid compositions are typically diluted to less than 1 wt-%, often less than 0.1 wt-%.

pH of Composition

The rinse aid composition can be any of acidic, basic, or neutral, and typically has a pH of about 2-11. Most compositions have a pH of about 3-9. Slightly acidic compositions are preferred, as they will dissolve hard water minerals that may stick to the surfaces being rinsed.

Any suitable additive can be added to modify the pH, some of which are discussed below. Preferably, any pH modifying additive is a GRAS ingredient. Examples of GRAS ingredients to adjust the pH include vinegar and baking soda.

Viscosity of Composition

The viscosity of a liquid rinse aid composition can vary widely, depending on the form of the composition. It is understood that a composition in a gel form will have a higher viscosity than a composition in liquid form. The viscosity should be such that the rinse aid composition can be dispensed from its package and that it can be properly applied in the dishwasher during the rinse cycle.

Optional Ingredients

The rinse aid composition may include other, optional ingredients on the GRAS list.

A builder may be included in the rinse aid composition to control mineral hardness, however, a builder is not present in the preferred compositions. Builders include chelating agents (chelators), sequestering agents (sequestrants), detergent builders, and the like. The builder often stabilizes the compositions. The level of any builder can vary widely, however, the preferred use level should be such to allow dilution of the compositions with 20 grain water hardness to the use concentration without formation of undesirable precipitate.

Examples of builders include phosphonic acid and phosphonates, phosphates, aminocarboxylates and their derivatives, pyrophosphates, polyphosphates, ethylenediamene and ethylenetriamene derivatives, hydroxyacids, and mono-, di-, and tri-carboxylates and their corresponding acids. Other builders include aluminosilicates, nitroloacetates and their derivatives, and mixtures thereof. Preferred builders are water soluble and do not contain phosphorus. Aminocarboxylates are particularly preferred builders, including salts of ethylenediaminetetraacetic acid (EDTA), hydroxyethylenediaminetetraacetic acid (HEDTA), and diethylenetriaminepentaacetic acid.

An alkaline source may be added to the composition; however, alkaline sources are not present in the preferred rinse aid compositions. Similarly, an acidity source may be added, however, none is present in the preferred composition.

Amphoteric surfactants can be present in the rinse aid composition; however, none is present in the preferred compositions. Suitable amphoteric surfactants are commercially available from a number of sources. Examples of suitable alkalinity sources include alkali metal salts, acidic salts, inorganic alkalinity sources, and the like. Any of a variety of known sources of alkalinity can be used in conjunction with the invention.

The rinse aids of the present invention can further include additional functional materials or additives that provide a beneficial property, for example, to aid in dissolution during use. Examples of conventional additives include one or more of each of salt or additional salt, pH buffer, hardening agent, solubility modifier, water softener, precipitation threshold agent or system, antimicrobial agent, soil release agent, glass corrosion inhibitor, aesthetic enhancing agent (e.g., dye, odorant, perfume), bleaching agent, enzyme, activator for the active oxygen compound, tablet dissolution aid, other such additives or functional ingredients, and the like, and mixtures thereof. Adjuvants and other additive ingredients will vary according to the composition and its form. Any of these additives, however, should be listed on the GRAS list.

Ingredients Preferably Avoided

The rinse aid composition includes no anionic hydrotrope. Anionic hydrotropes are solubilizers and are known to shift the cloud point of a solution. Examples of common anionic hydrotropes in rinse aids are sodium xylene sulfonate and sodium cumene sulfonate.

As stated above, the rinse aid composition also includes no material specifically added as a defoamer. Examples of defoamers include silicon-containing defoamers.

Packaging and Dispensing of the Composition

As stated above, the rinse aid concentrate composition may be a liquid or a solid material. Examples of suitable forms include a liquid, a gel, a powder, tablet, granules, pellets, block, and mixtures thereof. The rinse aid concentrate composition can be packaged in a variety of type of packages or packaging materials, such as, for example, a simple bottle or jar, a squeeze bottle, a “tear and pour” pouch, a box, single use packaging, or in water-soluble packaging. As stated above, the viscosity of the liquid rinse aid concentrate composition should be such that the composition can be readily dispensed from its package. The rinse aid concentrate composition may be dispensed by and diluted by the dishwasher. In another aspect of the invention, the rinse aid concentrate may be added as a unit dose charge to the dishwasher for dilution. In another aspect of the invention, the rinse aid concentrate may be diluted outside the dishwasher and transferred to the dishwasher for use.

Methods of Operation

The rinse aid functions during the rinsing and drying cycles of a washing procedure or program. A typical washing program includes one or more wash cycles, one or more rinse cycles, and then a drying cycle. The drying cycle can include passively drying in ambient conditions, or can include actively drying the surface by using any technology known for accelerating the drying process. A common drying accelerant is heat.

The present invention can be better understood with reference to the following examples. These examples are intended to be representative of specific embodiments of the invention, and are not intended as limiting the scope of the invention.

### EXAMPLES

### Example 1

### Selection of EO/PO Copolymer Mixture with Targeted Cloud Points

The 1% and 10% cloud points of various mixtures of “Pluronic 25R8” EO/PO copolymer (available from BASF), “Surfonic LDO-97” EO/PO copolymer (available from Huntsman Chemical), and “Neodol 25-12” alcohol ethoxlyate (available from Shell Chemical) were measured. “Pluronic 25R8” is a PO-terminated EO/PO copolymer. “Surfonic LDO-97” is a PO-terminated EO/PO copolymer. “Neodol 25-12” is an aliphatic, alcohol ethoxylate.

The results below show that when two PO-terminated EO/PO copolymers were mixed, the resulting cloud point of the mixture was not the theoretically expected, arithmetic average, cloud point. Applicants believe that this same phenomenon would apply if one copolymer is PO-termination and another is EO-terminated.

Additionally, the results below show that a mixture of EO/PO copolymers, having two PO-terminated polymers, do not follow the convention of having a higher cloud point at lower concentration and a lower cloud point at higher concentration, but rather the cloud point decreases as the concentration decreases and increases as the concentration increases. Applicants believe that this same phenomenon would also apply if one copolymer is PO-termination and another is EO-terminated.

For a desired rinse aid composition, target cloud points were about 120° F. or lower for a 1% solution and about 130° F. or higher for a 10% solution. As the data below illustrates, only the combinations of Surfonic LDO-97 and Pluronic 25R8, without the presence of Neodol 25-12, fit the desired criteria.

| | | | Expected | Expected | Actual | Actual |
|---|---|---|---|---|---|---|
| Wt-% | Wt-% | Wt-% | Cloud Pt | Cloud Pt | Cloud Pt | Cloud Pt |
| “Neodol 25- | “Surfonic | “Pluronic | (° F.) for | (° F.) for | (° F.) for | (° F.) for |
| 12” | LDO-97” | 25R8” | 10% | 1% | 10% | 1% |
| 100 | 0 | 0 | 250 | 245 | 249 | 245 |
| 75 | 25 | 0 | 217 | 211 | 202 | 197 |
| 50 | 50 | 0 | 175 | 177 | 155 | 150 |
| 25 | 75 | 0 | 152 | 144 | 140 | 132 |
| 0 | 100 | 0 | 120 | 110 | 122 | 110 |
| 75 | 0 | 25 | 188 | 211 | 175 | 180 |
| 50 | 0 | 50 | 160 | 177 | 165 | 168 |
| 25 | 0 | 75 | 115 | 144 | 162 | 163 |
| 0 | 0 | 100 | 70 | 107 | 70 | 107 |
| 0 | 25 | 75 | 82 | 110 | 135 | 115 |
| 0 | 50 | 50 | 95 | 110 | 142 | 115 |
| 0 | 75 | 25 | 107 | 110 | 128 | 106 |
| 25 | 25 | 50 | 127 | 143 | 153 | 149 |
| 25 | 50 | 25 | 140 | 143 | 148 | 140 |
| 50 | 25 | 25 | 172 | 177 | 161 | 159 |
| 12 | 13 | 75 | | | 162 | 150 |
| 12 | 75 | 12 | | | 133 | 128 |
| 75 | 12 | 13 | | | 174 | 176 |
| 33 | 33 | 34 | | | 154 | 150 |

### Example 2

### Preparation of an all GRAS Liquid Rinse Aid Microemulsion

A 10% solution of “Surfonic LDO-97” in water and a 10% dispersion of “Pluronic 25R8” in water were prepared. Combination of these two mixtures at ambient temperature at a 3:1 ratio of “LDO-97” to “25R8” provided a clear mixture, which Applicants believed to be a microemulsion.

The resulting liquid concentrate rinse aid was 90 wt-% water and 10 wt-% EO/PO (formed by a mixture of two copolymers at a 3:1 ratio).

The microemulsion was tested as a rinse aid in a common, residential dishwasher. The rinse aid was self-defoaming during use and was stable at warehouse temperatures of up at 120° F.

### Example 3

### Preparation of an all GRAS Liquid Rinse Aid Microemulsion

An aqueous mixture having 7.5 wt-% “Surfonic LDO-97” and 2.5 wt-% “Pluronic 25R4” in water was heated until the “25R4” had melted. The mixture was then cooled to ambient temperature with stirring, resulting in a clear mixture, which Applicants believed to be a microemulsion.

The resulting liquid concentrate rinse aid was 90 wt-% water and 10 wt-% EO/PO (formed by a mixture of two copolymers at a 3:1 ratio).

The microemulsion was tested as a rinse aid in a common, residential dishwasher. The rinse aid was self-defoaming during use and was stable to warehouse temperatures of up to 120° F.

### Example 4

### Preparation of Solid all GRAS Rinse Aid

First, 5 grams of tap water was mixed with 20 grams of urea powder, and then 75 grams of a 1:1 mixture of “Surfonic LDO-97” to “Pluronic 25R8” was added.

The resulting solid rinse aid composition was composed of 75 wt-% EO/PO copolymer (formed by a mixture of two copolymers at a 1:1 ratio), 20 wt-% urea, and 5 wt-% moisture.

The composition was a hard solid block that was suitable for use as a rinse aid.

It should be noted that, as used in this specification and the appended claims, the singular forms “a,” “an” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

The invention has been described with reference to various specific and preferred embodiments and techniques. However, it should be understood that many variations and modifications may be made while remaining within the spirit and scope of the invention.

What is claimed:

1. A rinse aid composition comprising at least one EO-PO copolymer, the composition having a cloud point of no greater than about 120° F. when the composition has an EO/PO concentration of 1 wt-%, and the composition having a cloud point of no less than about 130° F. when the composition has an EO/PO concentration of 10 wt-%.

2. The composition according to claim 1, wherein the composition has a cloud point of no greater than about 110° F. when the composition has an EO/PO concentration of 1 wt-%, and the composition has a cloud point of no less than about 140° F. when the composition has an EO/PO concentration of 10 wt-%.

3. The composition according to claim 1 consisting of ingredients that are listed as GRAS according to 21 C.F.R. 172, 21 C.F.R. 178, 21 C.F.R. 181, 21 C.F.R. 186, and/or 21 C.F.R. 582.

4. The composition according to claim 1 consisting of water and ingredients that are listed as GRAS according to 21 C.F.R. 172, 21 C.F.R. 178, 21 C.F.R. 181, 21 C.F.R. 186, and/or 21 C.F.R. 582.

5. The composition according to claim 1, wherein the EO/PO copolymer is PO-terminated.

6. The composition according to claim 1 further comprising a second EO/PO copolymer.

7. The composition according to claim 6, wherein the second EO/PO copolymer is PO-terminated.

8. A rinse aid composition consisting of ingredients that are listed as GRAS according to 21 C.F.R. 172, 21 C.F.R. 178, 21 C.F.R. 181, 21 C.F.R. 186, and/or 21 C.F.R. 582.

9. A rinse aid composition consisting of water and ingredients that are listed as GRAS according to 21 C.F.R. 172, 21 C.F.R. 178, 21 C.F.R. 181, 21 C.F.R. 186, and/or 21 C.F.R. 582.

10. A rinse aid composition comprising at least two EO/PO copolymers, at least one of the two EO/PO copolymers being PO-terminated, the composition being free of all hydrotropes and defoamers.

11. The rinse aid composition according to claim 10, wherein at least two EO/PO copolymers are PO-terminated.

12. The composition according to claim 9, consisting of ingredients that are listed as GRAS according to 21 C.F.R. 172, 21 C.F.R. 178, 21 C.F.R. 181, 21 C.F.R. 186, and/or 21 C.F.R. 582.

13. The composition according to claim 9, consisting of water and ingredients that are listed as GRAS according to 21 C.F.R. 172, 21 C.F.R. 178, 21 C.F.R. 181, 21 C.F.R. 186, and/or 21 C.F.R. 582.

14. A rinse aid composition comprising at least two EO/PO copolymers, each of the EO/PO copolymers being PO-terminated, the composition consisting of water and ingredients that are listed as GRAS according to 21 C.F.R. 172, 21 C.F.R. 178, 21 C.F.R. 181, 21 C.F.R. 186, and/or 21 C.F.R. 582.
